(19) United States
(12) Patent Application Publication
(10) Pub. No.: US 2026/0250213 A1
(43) Pub. Date: Aug. 27, 2026

(54) METHOD OF PROCESSING HOPS PLANTS INTO PELLETS, FEEDSTOCK, AND FERTILIZER

(71) Applicant: GTF, LLC, Ada, MI (US)

(72) Inventors: Jay Fournier, Grand Rapids, MI (US); Madison Hoffman, Grand Rapids, MI (US); Michael Nicolas, Holland, MI (US)

(21) Appl. No.: 19/162,816

(22) PCT Filed: Mar. 5, 2024
(86) PCT No.: PCT/US2024/018486

§ 371 Date: Sep. 5, 2025

Related U.S. Application Data
(60) Provisional application No. 63/450,555, filed on Mar. 7, 2023.

(51) Int. Cl. C05F 11/00; A23K 20/111

(52) U.S. Cl. CPC C05F 11/00; A23K 20/111

(57) ABSTRACT

A method of processing hops plants which reduces manufacturing time, produces higher quality hops products with rel-A atively higher terpene percentages, and recycles production waste into animal feed and fertilizer. The method uses a pressure mill to simultaneously pulverize and dry the hops, thus serving as a vast improvement over the prior art's current method of lengthy kiln drying and contact grinding. The temperature and speed of the pressure milling process can be varied to adjust the quality of the final hops product. Waste hops vines are processed by a pressure mill and thus transformed into fertilizer and animal feed.

### PRIORITY

This application claims priority to U.S. provisional application Ser. No. 63/450,555, filed Mar. 7, 2023, the entire contents of which is incorporated herein by reference.

### TECHNICAL FIELD

This invention pertains to the method of using a pressure mill to process hops plants into beverage-brewing hops pellets, fertilizer, and animal feed.

### BACKGROUND OF THE INVENTION AND TECHNICAL PROBLEMS POSED BY THE PRIOR ART

In 2022 alone, the United States beer industry produced over 660 billion dollars in revenue. The plant humulus lupulus, colloquially referred to as “hops,” is an essential ingredient used in this industry. Without hops, beer cannot be brewed and the beer industry would collapse. Hops plants, however, cannot be used in their raw form to brew beer. Instead, harvested hops must be carefully processed and prepared in an extensive and expensive series of steps that make hops usable for the brewing process. The present invention improves this hops preparation process.

Hops plants are composed of four usable parts: the hops stem, the hops leaves, the hops cones, and the hops roots. When hops are harvested, the stems, leaves, and cones are cut off from the roots and the roots are discarded. In this publication, the hops stem and leaves are hereafter collectively referred to and defined as vines. The hops cones contain oils called terpenes that are used by the brewing industry to manufacture beer. These oils, however, are sensitive to oxygen and heat. The longer a batch of hops is exposed to these degradation factors, the more terpenes are oxidized and damaged, decreasing the quality of the batch. Because higher oil percentages provide higher quality hops batches that sell for increased amounts of money, the hops industry values techniques and innovations that reduce the amount of oxidation hops undergoes.

The hops industry's current process of preparing hops for beer production involves numerous steps and is both time-intensive, costly, and wasteful. First, hops plants must be harvested. Second, the cones must be separated from the plant's vine. Third, the cones must be dried in kilns. This cone drying step represents a significant portion of the time and expense needed to process hops into a usable form.

Due to the high volume of hops needed in brewing beverages, the kilns used in the current hops prior art take the form of massive rooms that heat meter-high layers of hops over the course of one to two days. This lengthy drying process, and the associated cost of energy from running the massive kiln, incur high costs for hops producers. Further adding to this expense is the fact that long drying periods increase hops storage costs and force producers to harvest hops in batches (as limited by the size of the kiln). This batch harvesting means hops plants are subject to spoilage as farmers cannot always harvest their entire crops at peak ripeness because kiln space might not be available.

Another disadvantage of the current kiln drying system is that the lengthy time needed to kiln-dry exposes the cones to oxygen and heat for a prolonged period of time, therefore accelerating the cone's terpene degradation. Although this kiln-induced terpene degradation is undesirable, the current prior art has been unsuccessful in avoiding the kiln-enhanced oxidation and the hops production industry currently views kiln-oxidation as an unavoidable downside to the drying process. Hops producers have previously spent immense amounts of time and money to solve the kiln oxidation problem, but failed to succeed. The drying step is crucial to the production of hops because if hops cones are not sufficiently dehydrated, the moisture in the cones turns the hops into paste during the subsequent grinding step.

Fourth, the dried hops are pressed into bales and wrapped in airtight covers. These dried hops bales are then refrigerated. The airtight wrapper reduces oil oxidation by preventing oxygen from reaching the hops and the refrigeration slows down the oxidation chemical reaction to preserve the oil content of the hops cones. This wrapping and refrigeration step adds further cost to the hops preparation process due to the cost of the wrappers and of running the refrigeration equipment. Furthermore, the wrappers are not easily reused and contribute significant amounts of plastic waste to the environment each year.

Fifth, once the hops bales have finished refrigeration, the bales of hops are fed into a contact milling apparatus that grinds the hops cones into a mulch. For the purposes of this application, contact grinders are defined as a device that grinds products (hops) through direct contact between the grinding surface of the mill and the product. Impact mills and friction grinders are examples of contact mills because they use a surface of the mill to grind product. Currently, all hops production methods exclusively use impact or friction grinders.

Sixth, the milled hops cones are then compressed into hops pellets, and then packaged together and sold to brewers for beverage production.

The seventh and last step of hops production is disposing of the separated hops vines. Studies have shown that over 75% of hops biomass is not used in beer production and is dumped in landfills or burned, thus damaging the environment.

The invention disclosed by this patent is a method of processing hops which addresses one or more of these aforementioned inefficiencies in the hops industry's current hops processing method. The invention seeks to reduce hops preparation costs, dramatically shorten hops preparation time, solve the long-felt problem of kiln-induced oxidation hops oil oxidation, and efficiently recycle hops waste.

### SUMMARY OF THE INVENTION

According to broad aspects of one form of the present invention, the claimed method is a procedure to process hops plants and produce higher quality hops for beverage brewing, and to simultaneously reduce the waste inherent in the hops production process by transforming the hops vines into animal feed and fertilizer.

The claimed method is used after hops cones are separated from the hops plant's vines. The hops cones are fed into a pressure mill which pulverizes the cones into a finer particulate. Cone particulate is then optionally mixed with other previously-pulverized hops cones and formed into pellets that are used in the brewing process. After the hops cones have finished their reduction into particulate, the hops vines may be fed through the pressure mill to produce a hops vine particulate. The hops vine particulate may be optionally mixed with additives and used as animal feed or plant fertilizer.

The inventors of the claimed method have found, surprisingly and unexpectedly, that grinding hops with a pressure mill results in better quality hops with higher percentages of terpene oils. Furthermore, the pressure mill unexpectedly reduces the time, volumetric space, and money needed to transform hops cones into a form usable by beverage brewers.

According to one broad form of the present invention, the claimed method of processing hops plants includes a first step of providing a pressure mill and hops cones. The method includes the step of placing hops cones into the pressure mill and the further step of using the pressure mill to reduce the cones into a particulate via substantially non-impact pressure and shearing forces in the pressure mill. The method includes the further step of removing the particulate from the pressure mill.

In one preferred form of the method of the present invention, the method includes the step of forming the particulate into hops pellets. In still another preferred form of the method, the step of forming the particulate into hops pellets includes compacting the particulate.

In another preferred form of the method of the present invention, the method includes the step of blending the hops cone particulate hops with other hops particulate and forming the resulting, combined particulates into hops pellets. In still another preferred form of the method, the step of forming the particulate into hops pellets includes compacting the particulates.

In yet another preferred form of the method of the present invention, the step of using the pressure mill to reduce the cones into a particulate via substantially non-impact pressure and shearing forces is characterized in that the cone particulate has a percentage by weight of 0.001% to 10% of terpenes, wherein the terpenes are selected from the group consisting of myrcene, beta-myrcene, caryophyllene, beta-caryophyllene, caryophyllene oxide, trans-caryophyllene, farnesene, limonene, humulene, alpha-humulene, isoborneol, terpineol, alpha-terpineol, pinene alpha-pinene, beta-pinene, geraniol, and linalool.

According to another preferred form of the method of the present invention, the step of using the pressure mill to reduce the cones into a particulate via substantially non-impact pressure and shearing forces is characterized by operating or running the pressure mill between 3,000 RPM to 15,000 RPM when pulverizing and reducing the hops cones.

According to another preferred form of the method of the present invention, the step of using the pressure mill to reduce the cones into a particulate via substantially non-impact pressure and shearing forces is characterized by operating or running the pressure mill with a temperature inside the mill's chamber between 75° F. to 350° F. when pulverizing and reducing the hops cones.

In one preferred form of the method of the present invention, the step of using the pressure mill to reduce the cones into a particulate via substantially non-impact pressure and shearing forces is characterized by operating or running the pressure mill with a humidity inside the chamber of the pressure mill between 20% to 90% when pulverizing and reducing the hops cones.

In one preferred form of the method of the present invention, the method includes the further step of using the pressure mill to pulverize and reduce the hops cones until the particulate has a moisture content percentage between 1% to 20%.

In another preferred form of the method of the present invention, the method includes the further step of running the pressure mill with an airflow through the mill between 500 cubic feet per minute to 3,000 cubic feet per minute when pulverizing and reducing the hops cones.

In one preferred form of the method of the present invention, the method includes the further step of placing inert gases into the chamber of the pressure mill during the pulverization and reduction of the hops cones into particulate.

In another preferred form of the method of the present invention, the method includes the further steps of forming the particulate into hops pellets, cooling the pellets to a lower temperature, which may optionally further include the step of adding one or more inert gas to the pellets, and sealing the pellets in an airtight package, which may optionally further include the step of placing one or more inert gases into the airtight package.

According to another broad form of the present invention, the claimed method of processing hops plants includes a first step of providing a pressure mill and hops vines. The method includes the step of placing hops vines into the pressure mill and the further step of using the pressure mill to reduce the hops vines into a vine particulate via substantially non-impact pressure and shearing forces in the pressure mill. The method includes the further step of removing the vine particulate from the pressure mill

In one preferred form of the method of the present invention, the method includes the further step of using the vine particulate as animal feed.

In one preferred form of the method of the present invention, the method includes the further steps of creating a mixture of vine particulate by adding one or more nutritional supplements or medications, into the vine particulate, and using the mixture as animal feed.

According to another preferred form of the method of the present invention, the method includes the further steps of forming the vine particulate into chips, pellets, or bales, and using the formed vine particulate chips, pellets, or bales as animal feed.

In another preferred form of the method of the present invention, the method includes the further step of using the vine particulate as plant fertilizer.

In one preferred form of the method of the present invention, the method includes the further steps of mixing the vine particulate with a fertilizer additive, which optionally further comprises the step of mixing another type of fertilizer with the vine particulate, and using the mixture as plant fertilizer.

According to yet another broad form of the present invention, the claimed method of processing hops plants includes a first step of providing a pressure mill and hops cones. The method includes the step of placing hops cones into the pressure mill and the further step of using the pressure mill to reduce the hops cones into a particulate via substantially non-impact pressure and shearing forces in the pressure mill. The method includes the further step of removing the particulate from the pressure mill. The method includes the steps of providing hops vines and placing hops vines into the pressure mill. The method includes the further step of using the pressure mill to reduce the hops vines into a vine particulate via substantially non-impact pressure and shearing forces in the pressure mill. The method includes the further step of removing the vine particulate from the pressure mill.

In another preferred form of the method of the present invention, the method includes the further step of using the pressure mill to reduce the cones into a particulate via substantially non-impact pressure and shearing forces in the pressure mill, wherein the cone particulate has a percentage by weight of 0.001% to 10% of terpenes, wherein the terpenes are selected from the group consisting of myrcene, beta-myrcene, caryophyllene, beta-caryophyllene, caryophyllene oxide, trans-caryophyllene, farnesene, limonene, humulene, alpha-humulene, isoborneol, terpineol, alpha-terpineol, pinene alpha-pinene, beta-pinene, geraniol, and linalool.

In another preferred form of the method of the present invention, the method includes the further step of using the pressure mill to pulverize and reduce the hops cones until the particulate has a moisture content percentage between 1% to 20%.

It should be appreciated that the invention may include any or all of the above-described features and steps, include only one of the above-described steps, more than one of the above-described steps, and any combination of the above-described steps. Furthermore, other objects, features and advantages of the invention will become apparent from a review of the entire specification including the appended claims and drawings.

### BRIEF DESCRIPTION OF THE DRAWINGS

In the accompanying drawings forming part of the specification, in which like numerals are employed to designate like parts throughout the same,

FIG. 1 is an isometric view, from above, of an exemplary pressure mill for use in performing the methods of the present invention;

FIG. 2 is an isometric view, from above, of a pellet formation press for use in performing the methods of the present invention;

FIG. 3 is a diagram flowchart of the prior art for processing hops into a form usable by beverage brewers;

FIG. 4 is a diagram flowchart of a method of processing hops cones according to the present invention;

FIG. 5 is a diagram flowchart of a method of processing hops vines according to the present invention; and

FIG. 6 is a diagram flowchart of a method of processing all hops plant components according to the present invention.

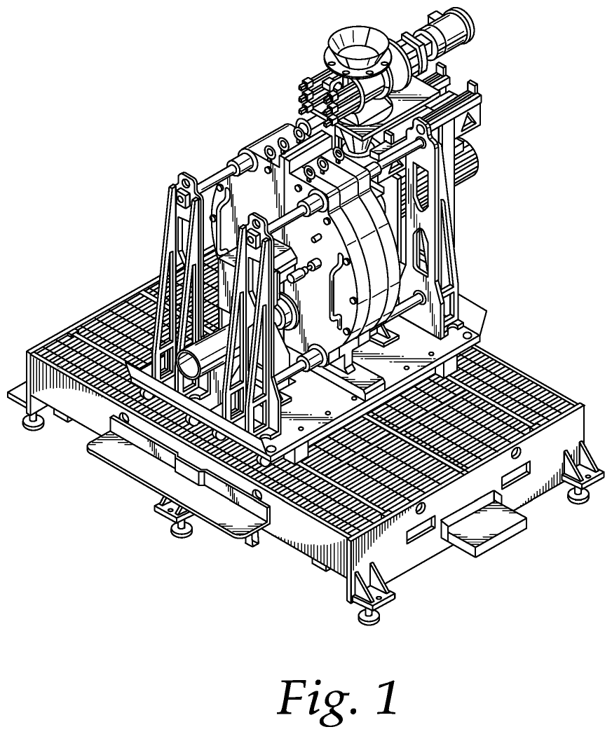

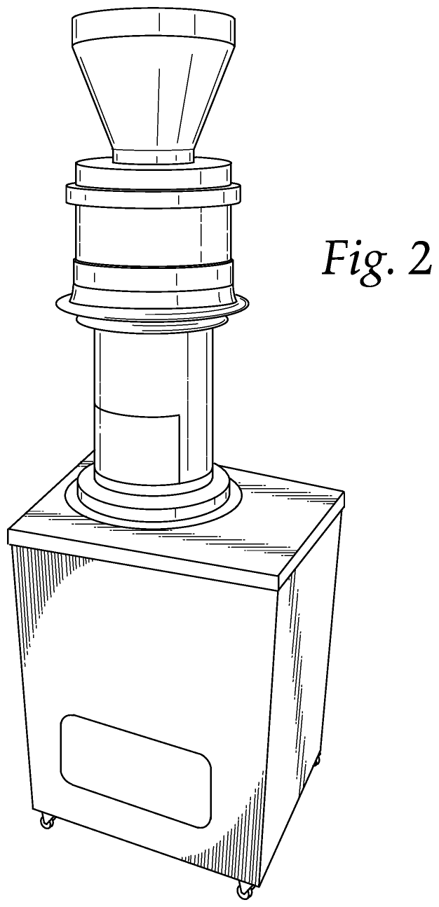

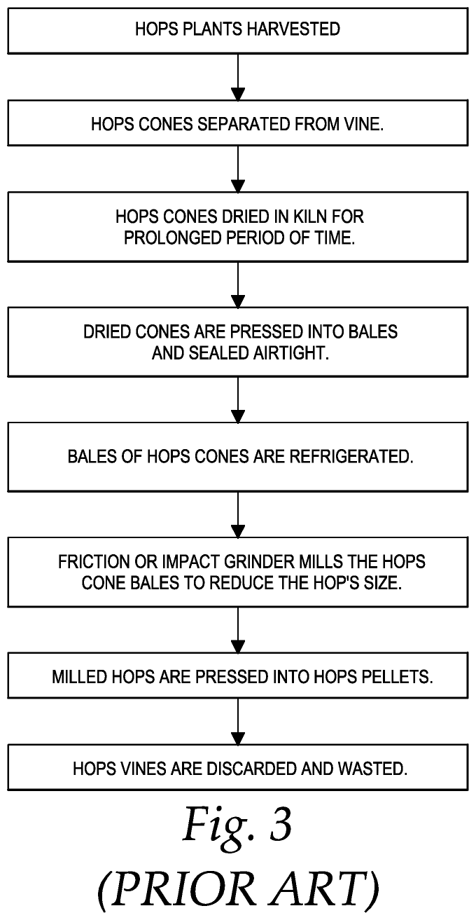

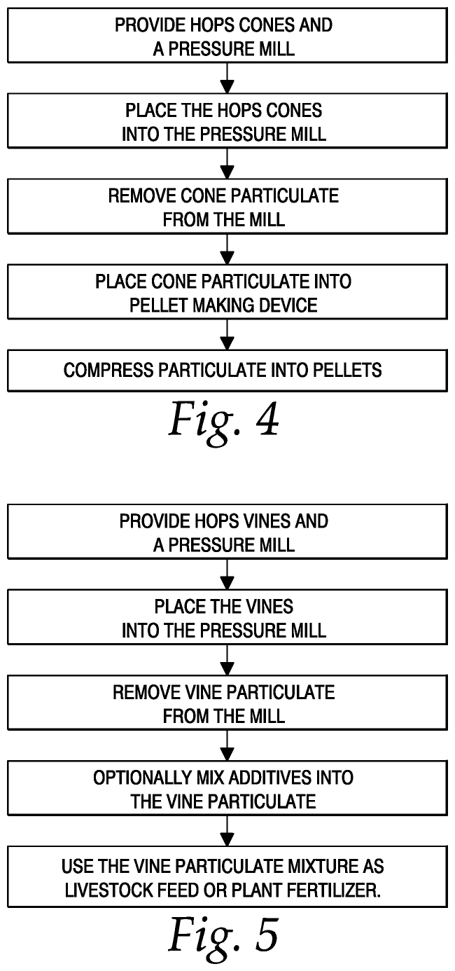

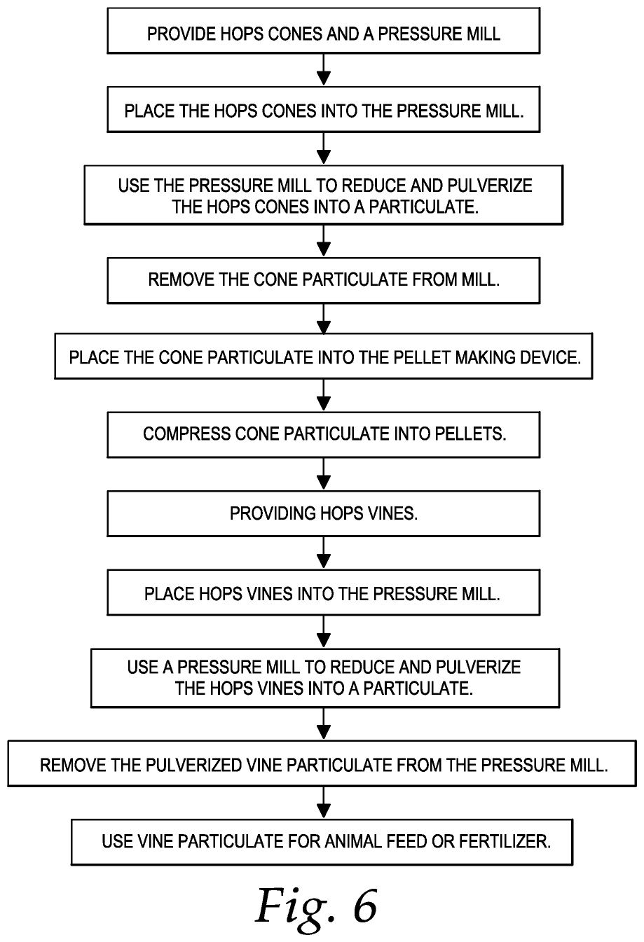

### DESCRIPTION OF THE PREFERRED EMBODIMENTS

A pressure mill is an apparatus that uses air pressure to pulverize material into smaller pieces by moving the material between high-and low-pressure areas inside a chamber. The mill includes six basic or central components: a housing defining an internal cavity or enclosed chamber, an inlet at the front of the housing to the mill, an outlet at the rear of the housing of the mill, at least one lobe on the interior circumference of the chamber (though more than one lobe is preferable), a rotor plate with vanes or vane blades affixed to a rotating shaft that runs through the center of the chamber (collectively known as a rotor assembly), and a motor to turn the rotor assembly relative to the lobes. The housing preferably is comprised of multiple lobe plates that are stacked or assembled to the desired axial depth of the mill. The pressure mill functions when the rotor plate is spun at about 2,500 to about 15,000 revolutions per minute (“RPM”), which creates a relatively high-pressure zone in front of the rotor plate near the inlet, and a relatively low-pressure zone behind the rotor plate near the outlet. The motor which turns the rotor plate can vary the rotational speed of the plate to match the desired RPM of the mill's operator. The rotor vanes of the rotor plate should extend from the center of the plate radially towards the edge of the plate. The vanes may extend in a straight line (not illustrated) or in a spiraling design, the choice of which affects efficiency depending on the material being pulverized. The vanes should terminate at the radial edge or end of the plate, though in other embodiments of this invention the vanes terminate near the end of the plate or hang off the end of the edge of the plate.

When raw material is placed into the pressure mill, the difference between the mill's pressure zones creates a suction effect that pulls material from the front to the rear of the mill. As material follows this suction effect from the front to the rear of the mill, the rotor plate vanes redirect the material's flow out to the walls of the chamber. This redirection forces the material being processed to flow and circle around the inner surface of the walls of the chamber while simultaneously being drawn towards the rear of the mill by the pressure zone suction. The flow of air from the front of the mill to the back of the mill is measured in cubic feet per minute (CFM), and can be varied to change the properties of the final pulverized product exiting the mill.

As the vanes move the material around the perimeter of the chamber, the material regularly encounters lobes extending from or embedded in the inner surface of the chamber. The lobes serve a twofold purpose. First, the narrow distance between the lobe and the vane tips creates a shockwave whenever a vane passes the lobe. Pressure mills are not contact mills because the pulverization of the product does not occur from contact between a surface of the pressure mill and the product. Instead, as material circles the walls of the chamber and enters this space between the lobes and rotor assembly, the resulting shockwaves pulverize the material into relatively smaller pieces via substantially non-friction and non-impact forces. These non-impact forces pulverize the material via pressure, resonance, shock, and shearing forces to reduce the material to a relatively smaller size.

Second, the angled shape of the lobe redirects the material being pulverized back towards the center of the mill. This redirection forces the material back into the vanes, which redistributes the material back onto the surface of the chamber walls for further shockwave pulverization at the lobes.

Eventually, after being pulverized numerous times, the material reaches a fine enough pulverized condition that the material becomes a particulate and the suction effect of the mill is sufficient to drag the material beyond the rotor assembly towards the back of the mill. Upon reaching the back of the chamber, the suction effect of the mill pushes the pulverized material out of the rear outlet of the housing. This ejected material can then be optionally introduced to subsequent pressure mill chambers for further pulverization.

Importantly, while the illustrated embodiment of the pressure mill portrays a single chamber, it will be understood that there is no limit to the number of pressure mill chambers that can be used successively, as each chamber adds to the suction effect of the previous chamber and increases the granulate size consistency of the final output of the mill.

U.S. provisional patent application 63/421,479, U.S. patent application publication no. 2017/0252751A1 , and U.S. Pat. No. 6,227,473 all embody versions of a pressure mill and are incorporated by reference herein in their entireties. However, these prior art references are intended to serve as examples of what a pressure mill is, and how a pressure mill functions. These prior art references are not intended to limit the type of mill used in the claimed method to only the specific pressure mill types displayed in the prior arts. Instead, any person of ordinary skill in the art will recognize that many different variations of pressure mills exist, and that the defining feature of a pressure mill is that it pulverizes material via the use of substantially non-friction and non-impact forces that pulverize the material with pressure, resonance, shock, and shearing forces.

The inventors of the claimed method have found that, surprisingly and unexpectedly, the use of a pressure mill to grind hops results in better quality hops products that are produced in a fraction of the time and money needed under current prior art methods. These benefits of using a pressure mill result from the unexpected fact that extensive testing has revealed pressure mills are not an equivalent alternative to impact and friction mills for grinding hops. Instead, the inventor's tests have revealed that pressure mills provide a fundamentally different and a superior method of milling hops that has significant advantages over the conventional friction and impact mills used in the prior art.

Impact or friction mills do not produce significant amounts of heat during milling, meaning that such contact-based mills require that raw material be dried before milling (or else the material turns to paste during the impact or friction milling process). This requirement for pre-dried material adds time and cost to the contact milling process, and provides opportunity for the hops plant to oxidize and degrade in value.

While a pressure mill is in operation, however, the shockwaves generated in the mill's chamber produce a substantial amount of heat. This production of heat means that the byproduct of pressure milling dries the product as it is pulverized. This simultaneous dehydration and pulverization eliminate the aforementioned pre-drying costs associated with friction and impact milling hops.

The simultaneous pressure mill drying is preferable because it eliminates the prior art's lengthy and expensive kiln-drying process. Instead of having to wait days for hops to be dried and refrigerated before grinding, the claimed method allows hops farmers to mill the hops cones immediately after harvest. This reduced processing time saves hops farmers significant amounts of storage cost, and eliminates the expensive process of running a building-sized kiln to dry hops out.

Furthermore, because the pressure mill drying happens over the course of a few hours, and not over the course of several days like kiln drying, the pressure mill process completely avoids the kiln-enhanced oxidation problem that the hops production industry has been unable to avoid and eliminate. The very short relative pressure milling time (a couple hours as compared to several days with a kiln) oxidizes and degrades the oils at a massively reduced rate compared to kiln drying. Therefore, the hops produced from the claimed invention have a higher terpene oil percentage and quality than kiln dried hops. Hops with higher oil and terpene percentages are considered by brewers to be of higher quality, and therefore brewers pay more for hops with high relative percentages of hops terpenes.

The oils in hops contain a class of hydrocarbon molecules named terpenes. Each terpene provides a different flavor to beer, causing brewers to value hops with a relatively high percentage of terpenes per weight. The terpenes most valued in hops production are myrcene, beta-myrcene, caryophyllene, beta-caryophyllene, caryophyllene oxide, trans-caryophyllene, farnesene, limonene, humulene, alpha-humulene, isoborneol, terpineol, alpha-terpineol, pinene, alpha-pinene, beta-pinene, geraniol, and linalool. However, this list of terpenes and hops compounds is not exhaustive and other terpenes and hops compounds are also valued and used by the brewing industry.

Unexpectedly, hops cones processed by pressure mills have been found to have higher percentages of these terpenes as compared to hops processed by the prior art's impact and friction milling methods. It is presently believed by the inventors that the hops processed according to the present invention may have about 20% higher percentage of terpenes compared to hops processed by the prior art methods.

An optional variation of the claimed invention may be used where an inert gas, like nitrogen, carbon dioxide, or argon (but not limited solely to nitrogen, carbon dioxide, or argon), or a combination of inert gases, is used inside the pressure mill's chamber. This inert gas displaces oxygen in the pressure mill and therefore prevents terpene oxidation during the milling process. Hops milled with the use of such inert gas has even higher terpene percentage values, and is therefore valued more by beverage brewers.

The second significant advantage the use of the pressure mill has is that pressure milling allows hops farmers greater flexibility in harvesting their crops. Instead of having to time harvest around when kilns are available for drying, farmers can process hops as they are brought in from the field. This allows hops to be harvested at their optional ripeness when hops have optimal terpene counts and therefore produces higher quality hops products with high end percentages of terpenes.

The third advantage from using a pressure mill is that a pressure mill is space-efficient. A pressure mill requires only a few square meters of floor space to operate, while a drying kiln necessitates hundreds of square meters in size and often occupies an entire warehouse building. The claimed method's smaller space requirement will reduce farmer production costs and allow smaller hops farmers (who do not have the land or finances to support large kiln facilities) to efficiently join the commercial hops market.

The fourth and final advantage of using a pressure mill to process hops is that the size of particles produced by a pressure mill can be decreased by increasing the pressure mill's rotational speed. This means a pressure mill can grind hops to a finer particulate size than traditional impact or friction mills. Because substances ground to a smaller particulate size have larger surface area than larger particles, hops pulverized by a pressure mill have a greater surface area than hops ground by impact or friction mills. This increased surface area directly translates to a superior hops product for brewing because increased surface area allows brewers to extract more oils from hops than the brewer would otherwise be capable of achieving.

The quality of pulverized hops can be controlled by varying the pressure mill's operating parameters. Aside from oil percentage count, one of the key factors determining hops quality is the hops' moisture content post pulverization. The hop's end-moisture content can be controlled by varying the pressure mill's operating parameters. The most important of these variable mill parameters are: the pressure mill's RPM, the pressure mill's internal humidity, the pressure mill's internal temperature, and the pressure mill's internal airflow

A user of the claimed method can control with precision the moisture content of the final pulverized hops product by measuring and controlling the internal humidity of the pressure mill's chamber. In the claimed invention's preferred embodiment, an internal mill humidity of eighty percent results in an ideal final product moisture between six and fifteen percent. However, other humidity ranges are desirable for different hops variants, so the claimed method includes variances of the internal humidity from a range of 10% to 90%. This measurement can be accomplished with a humidity sensor, and the humidity can be adjusted by adding or removing water from the pressure mill's interior during operation. Alternatively, humid air can be fed into the mill to adjust the mill's internal humidity.

The moisture content of the processed hops can be further controlled by measuring and controlling the internal temperature of the pressure mill chamber during operation. The hotter the internal temperature of the mill, the less moist the final hops product is after processing. Conversely, the cooler the internal temperature of the mill, the moister the final hops product will be after processing. The measurement of the mill and product's internal temperature can be accomplished with temperature sensors. The temperature of the mill and product can be adjusted via heating or cooling elements in the mill, by feeding hot or cool air or liquid into the mill during operation, or by heating or cooling the hops before placing them into the mill. The ideal embodiment of the claimed invention will have a temperature between 75 degrees Fahrenheit and 350 degrees Fahrenheit.

The moisture content of the processed hops can be further controlled by measuring and controlling the revolutions per minute (RPM) of the mill during operation. The higher the RPM of the mill, the less moist the final hops product will be after processing. Conversely, the lower the RPM of the mill, the moister the final hops product will be after processing. The ideal embodiment of the claimed invention will create an ideal hops product at an RPM between 3,000 and 15,000 RPM, but other RPM outside of this range will still produce a hops product superior to the prior art.

The moisture content of the processed hops can also be controlled by measuring and controlling the flow of air through the mill. When more air is fed through the pressure mill, the moisture of the final hops product is decreased. Conversely, when less air is fed through the pressure mill, the moisture of the final hops product is increased. The measurement of the pressure mil's airflow can be accomplished with airflow sensors in or around the mill. The airflow of the mill itself can be controlled with fans, turbines, gates, fins, flaps, and other similar air flow modifying devices. The ideal embodiment of the claimed invention will have an airflow between 300 and 3,000 cubic feet per minute (CFM).

After the pressure mill finishes crushing and drying the cones, the pulverized hops cones are removed from the pressure mill and pelletized. This process can occur immediately after pulverization and does not need to be delayed for an intermediate refrigeration and baling step like the state of the prior art prescribes.

Hops pellets can be formed through numerous ways, though the preferred method is through the application of pressure and optional binding agents. One way this pelletization process can occur is by placing the pulverized hops into a chamber with a powered piston. When the piston is activated, it pushes the pulverized hops together into a compact clump that maintains its compressed form after the pressure is removed.

If smaller pellets are desired, the end of the chamber opposite the piston is replaced with a grate that contains holes. As the piston compresses the pulverized hops, the piston extrudes the hops through the grate's holes into columns of compressed hops cone. The compressed and extruded columns are then sliced into short lengths to create small, individual pellets. Once the pellets are finished, they are gathered and sold to brewers for beverage production.

In an optional variation of the claimed invention, the pelletized hops are cooled or frozen immediately after pelletization, and then optionally sealed into airtight containers or packaging. This combination of cooling and airtight storage further curtails the oxidation process inherent in the prior art's kiln-drying and contact milling process. The airtight packaging is of especial value in this optional variation because the packaging prevents oxygen from reaching the hops pellets. The airtight packages of hops pellets can be flushed with an inert gas before the package is sealed to remove all oxygen from the package and further reduce terpene oxidation.

This combination of cooling and airtight sealing can be maximized if the pelletized hops are supercooled with an inert substance like liquid nitrogen. The extreme cold of the liquid nitrogen instantly freezes the hops. The instant freeze stops oxidation, while the associated inert nitrogen gas prevents oxygen from reaching the hops during the cooling process.

The claimed process also has unexpected and surprising results when a pressure mill is used to process hops vines. Under the prior art, tens of thousands of tons of hops vines are dumped into landfills every year, creating significant amounts of environmental waste as a by-product of hops pellet production. The claimed method, however, avoids these environmental problems by recycling the waste into a useable format. First, the vines are fed into the pressure mill and pulverized until they have been crushed into a particulate. If a moister vine particulate is desired, the vine particulate's moisture can be varied by controlling the pressure mill's operational heat, airflow, and internal humidity. Some final uses of the vine particulate may prefer a higher moisture content. However, in this method's preferred embodiment, a low moisture content is preferred. The particulate is then removed from the mill.

The vine particulate is very useful for a variety of agricultural and culinary purposes. For example, the vine particulate makes excellent animal feed for livestock. The dehydrated form of the particulate makes it easy to store and transport without loss or difficulty, and is filled full of energy and nutrients for animals. The vine particulate can be packaged into chips, pellets, or bales, for easy distribution to livestock. Although vine particulate is nutritious for livestock on its own, its usefulness can be dramatically increased if livestock nutrition supplements or medications are mixed into the particulate. Examples of these supplements and medications can be, but are not limited to: flavoring agents, colorants, preservatives. Antioxidants, insecticides, antibiotics, mold inhibitors, mycotoxin binders, nutrient flow enhancers like sepiolite or zeolite, acidity regulators, hormonal supplements, digestibility enhancers, anti-parasite medications, dietary vitamins, dietary minerals, amino acids, immunomodulators, enzymes, protein, and probiotics.

Hops vine particulate animal feed may also be mixed with one or more other types of animal feed to form an effective mixed-type animal feed with an enhanced nutritional profile. Examples of these other types of animal feed can be, but are not limited to: corn, wheat, oats, alfalfa, hay, beans, and soybeans.

Alternatively, the same nutrition and transport qualities of vine particulate make it a very useful fertilizer. When applied directly to growing plants, or optionally first fermented before application, the vine particulate makes an excellent fertilizer. The vine particulate can be mixed with additives to enhance the fertilizer's effectiveness. Examples of these fertilizer additives can be, but are not limited to: nitrogen, phosphorus, sulfur, and potassium.

Optionally, the Hops vine particulate and additive mixture may be further mixed with other types of fertilizer to form an effective mixed-fertilizer. Examples of other types of fertilizers that can be mixed with hops vine particulate are, but not limited to: animal manure-based fertilizers, plant refuse-based fertilizers, ammonium-based fertilizers, phosphate-based fertilizers, sulfate-based fertilizers, and potassium-based fertilizers.

The steps of cone pulverization and the step of vine pulverization may be performed simultaneously with separate pressure mills, or subsequent to each other if only one pressure mill is available.

### REFERENCES CITED IN SPECIFICATION

IMARC. Beer Market: Global Industry Trends, Share, Size, Growth, Opportunity and Forecast 2023-2028. Available at https://www.imarcgroup.com/beer-market#:~:text=Request%20Sample%20Market%20Overview%3A%20Th e%20global%20beer%20market, a%20growth%20rate%20%28CAGR%29%20of%201.9%25%20during%202023-2028.
Algazzali et al. A comparison of quality: Freeze-dried versus kiln-driedCascade hops. 2015 ASBC Annual Meeting. Available at https://www.asbcnet.org/events/archives/2015Meeting/proceedings/Pages/62.aspx
Brian Yaeger. How Are Hops Grown and Harvested? The Beer Connoisseur. Available at https://beerconnoisseur.com/articles/hops-grown-harvested
Patrick Grattan. The Process of Hop Drying. Oast and Hop Kiln History. http://oastandhopkilnhistory.com/oastsandhopkilns/the-process-of-hop-drying/

What is claimed is:

1. A method of processing hops plants comprising:
providing a pressure mill and hops cones;
placing hops cones into the pressure mill;
using the pressure mill to reduce the cones into a particulate via substantially non-impact pressure and shearing forces in the pressure mill;
and removing the particulate from the pressure mill.

2. A method of processing hops plants comprising:
providing a pressure mill and hops vines;
placing the hops vines into the pressure mill;
using the pressure mill to reduce the hops vines into a vine particulate via substantially non-impact pressure and shearing forces in the pressure mill;
and removing the vine particulate from the pressure mill.

3. A method of processing hops plants comprising:
providing a pressure mill and hops cones;
placing hops cones into the pressure mill;
using the pressure mill to reduce the hops cones into a particulate via substantially non-impact pressure and shearing forces in the pressure mill;
and removing the pulverized cone particulate from the pressure mill; and
which further comprises the steps of:
providing hops vines;
using the pressure mill to reduce the hops vines to a vine particulate via substantially non-impact pressure and shearing forces in the pressure mill;
and removing the pulverized vine particulate from the pressure mill.

4. The method of claim 1, further comprising the step of:
forming and optionally compacting the particulate into hops pellets.

5. The method of claim 1, further comprising the steps of:
blending the hops cone particulate hops with other hops particulate;
and forming and optionally compacting the combined particulates into hops pellets.

6. The method of claim 1, further comprising the step of:
using the pressure mill to reduce the cones into a particulate via
substantially non-impact pressure and shearing forces in the pressure mill,
wherein the cone particulate has a percentage by weight of 0.001% to 10% of terpenes, wherein said terpenes are selected from the group consisting of myrcene, beta-myrcene, caryophyllene, beta-caryophyllene, caryophyllene oxide, trans-caryophyllene, farnesene, limonene, humulene, alpha-humulene, isoborneol, terpineol, alpha-terpineol, pinene alpha-pinene, beta-pinene, geraniol, and linalool.

7. The method of claim 1, further comprising the step of:
running the pressure mill at an RPM between the range of 3000 to 15000
when pulverizing and reducing the hops cones.

8. The method of claim 1, further comprising the step of:
running the pressure mill with a temperature inside the mill's chamber between the range of 75° F. to 350° F. when pulverizing and reducing the hops cones.

9. The method of claim 1, further comprising the step of:
running the pressure mill with a humidity inside the mill's chamber between the range of 20% to 90% when pulverizing and reducing the hops cones.

10. The method of claim 1, further comprising the step of:
using the pressure mill to pulverize and reduce the hops cones until the particulate has a moisture content percentage between the range of 1% to 20%.

11. The method of claim 1, further comprising the step of:
running the pressure mill with an airflow through the mill between the range of 500 to 3000 cubic feet per minute when pulverizing and reducing the hops cones.

12. The method of claim 1, further comprising the step of:
placing inert gases into the chamber of the pressure mill during the pulverization and reduction of the hops cones into particulate.

13. The method of claim 1, further comprising the steps of:
forming and optionally compacting the particulate into hops pellets;
cooling the pellets to a lower temperature, which optionally further comprises the step of adding one or more inert gas to the pellets;
and sealing the pellets in an airtight package, which optionally further comprises the step of placing one or more inert gases into the airtight package.

14. The method of claim 2, further comprising the step of:
using the hops plant part particulate as animal feed.

15. The method of claim 2, further comprising the steps of:
creating a mixture of hops vine particulate by adding nutrition supplements
and optionally medication into the hops plant part particulate;
and using the vine particulate mixture as animal feed.

16. The method of claim 2, further comprising the steps of:
forming the hops vine particulate into chips, pellets, or bales;
and using the formed particulate as animal feed.

17. The method of claim 2, further comprising the step of:
using the hops vine particulate as plant fertilizer.

18. The method of claim 2, further comprising the steps of:
mixing the hops vine particulate with a fertilizer additive, which optionally further comprises the step of mixing another type of fertilizer with the vine particulate;
and using the vine particulate mixture as plant fertilizer.

19. The method of claim 3, further comprising the steps of:
using the pressure mill to reduce the cones into a particulate via substantially non-impact pressure and shearing forces in the pressure mill, wherein the cone particulate has a percentage by weight of 0.001% to 10% of terpenes, wherein said terpenes are selected from the group consisting of myrcene, beta-myrcene, caryophyllene, beta-caryophyllene, caryophyllene oxide, trans-caryophyllene, farnesene, limonene, humulene, alpha-humulene, isoborneol, terpineol, alpha-terpineol, pinene alpha-pinene, beta-pinene, geraniol, and linalool.

20. The method of claim 3, further comprising the steps of:
using the pressure mill to pulverize and reduce the hops cones until the particulate has a moisture content percentage between the range of 1% to 20%.
